(19) United States
(12) Patent Application Publication
(10) Pub. No.: US 2011/0280526 A1
(43) Pub. Date: Nov. 17, 2011

(54) Electrical Cable Having Return Wires Positioned Between Force Wires

(76) Inventors: Arash Behziz, Newbury Park, CA (US); Arthur G. Buck, Sherwood, OR (US)

(21) Appl. No.: 13/016,237

(22) Filed: Jan. 28, 2011

Related U.S. Application Data
(60) Provisional application No. 61/299,675, filed on Jan. 29, 2010.

(51) Int. Cl. G02B 6/44; H01B 9/02

(52) U.S. Cl. 385/101; 174/105 R

(57) ABSTRACT

An electrical cable includes a central wire extending a length between opposite ends. The central wire has a periphery. Force wires have winding turns that are wrapped around the periphery of the central wire along the length of the central wire. The force wires include force conductors surrounded by force insulators. Return wires have winding turns that are wrapped around the periphery of the central wire along the length of the central wire. The return wires include return conductors surrounded by return insulators. The winding turns of the return wires are interleaved between the winding turns of adjacent force wires such that the adjacent force wires are separated by at least one return wire.

### CROSS-REFERENCE TO RELATED APPLICATIONS

This application is an application under 35 USC 111(a) and claims priority under 35 USC 119 from Provisional Application Ser. No. 61/299,675, filed Jan. 29, 2010 under 35 USC 111(b). The disclosure of that provisional application is incorporated herein by reference.

### BACKGROUND OF THE INVENTION

The subject matter described and/or illustrated herein relates generally to electrical cables, and more particularly, to the arrangement of force and return wires within an electrical cable.

Electrical cables are used in a wide variety of applications for interconnecting a wide variety of electrical devices. For example, electrical cables are often used to deliver electrical power from a source to another electrical device, such as a printed circuit board, an electrical connector, and/or the like. As electrical devices become smaller, the signal paths thereof become more densely grouped. Due to such increased density, as well as ever increasing signal speeds, electrical power cables that supply electrical power to neighboring electrical devices may electrically interfere with the signals, which is commonly referred to as “noise”. Such noise from electrical power cables can become a relatively large contributor to errors along the signal paths, which may slow down and/or induce error in the electrical devices.

To reduce noise generated by electrical power cables, it is desirable to reduce the inductance of the electrical power path between the electrical power source and the electrical device. Some known attempts to create a reduced inductance power path use printed circuit boards to feed electrical power from the source to the electrical devices. But, such low inductance printed circuit boards are not flexible. Inflexible printed circuit boards are of limited use in systems wherein the electrical power source is remote from the electrical device and/or wherein the electrical power path must curve around various obstructions. Other known attempts to create reduced inductance power paths have used a flexible polyimide structure to obtain a lower inductance. However, such flexible substrates are expensive and may only be capable of providing a limited density of electrical power connections and/or paths. Finally, coaxial cables have been used to create reduced inductance power paths. But, low inductance coaxial cables may be more expensive than is desired.

### BRIEF DESCRIPTION OF THE INVENTION

In one embodiment, an electrical cable includes a central wire extending a length between opposite ends. The central wire has a periphery. Force wires have winding turns that are wrapped around the periphery of the central wire along the length of the central wire. The force wires include force conductors surrounded by force insulators. Return wires have winding turns that are wrapped around the periphery of the central wire along the length of the central wire. The return wires include return conductors surrounded by return insulators. The winding turns of the return wires are interleaved between the winding turns of adjacent force wires such that the adjacent force wires are separated by at least one return wire.

In another embodiment, an electrical cable includes force wires having force conductors surrounded by force insulators, and return wires having return conductors surrounded by return insulators. The force and return wires are arranged side by side in a first row and side by side in a second row that is stacked on the first row. A return wire within the first row is positioned between adjacent force wires within the first row such that the adjacent force wires are separated by at least one return wire. A force wire within the second row is positioned between adjacent return wires within the second row such that the adjacent return wires are separated by at least one force wire.

### BRIEF DESCRIPTION OF THE DRAWINGS

FIG. 1 is a perspective view of an exemplary embodiment of an electrical cable.

FIG. 2 is a perspective view of a portion of the cable shown in FIG. 1.

FIG. 3 is a cross sectional view of the cable shown in FIG. 1 taken along line 2-2 of FIG. 1.

FIG. 4 is a cross-sectional view of an exemplary alternative embodiment of an electrical cable.

FIG. 5 is a cross-sectional view of another exemplary alternative embodiment of an electrical cable.

FIG. 6 is a cross-sectional view of another exemplary alternative embodiment of an electrical cable.

FIG. 7 is a perspective view of another exemplary embodiment of an electrical cable.

FIG. 8 is a cross sectional view of the cable shown in FIG. 7 taken along line 8-8 of FIG. 7.

FIG. 9 is a cross-sectional view of an exemplary alternative embodiment of an electrical cable.

FIG. 10 is a cross-sectional view of another exemplary alternative embodiment of an electrical cable.

### DETAILED DESCRIPTION OF THE INVENTION

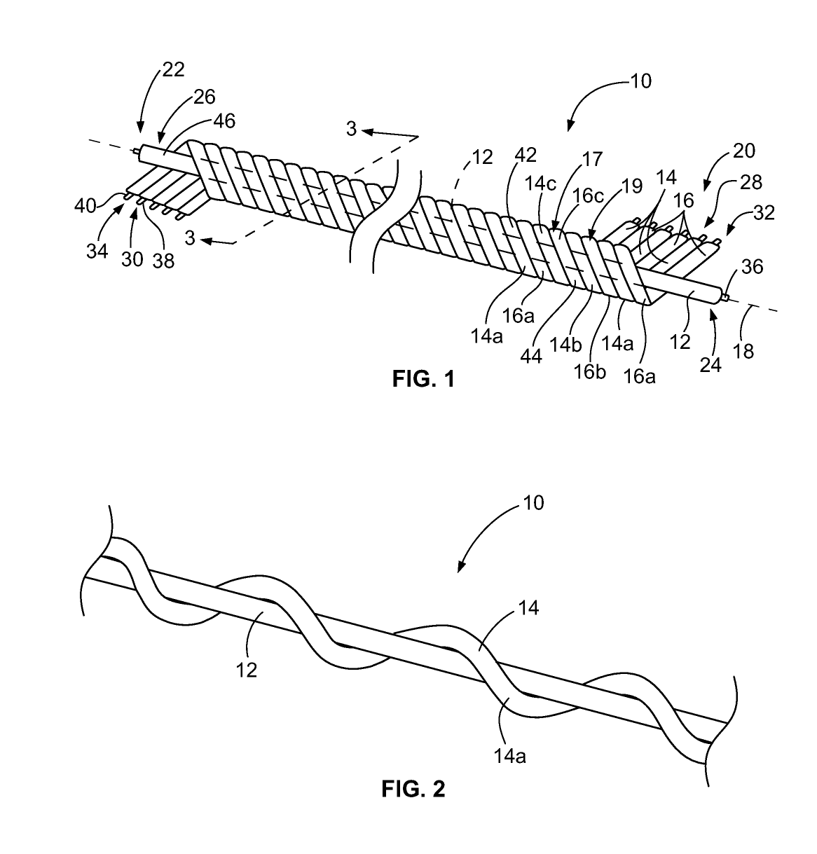

FIG. 1 is a perspective view of an exemplary embodiment of an electrical cable 10. The electrical cable 10 includes a central wire 12, a plurality of force wires 14, and a plurality of return wires 16. The cable 10 extends a length along a central longitudinal axis 18 from an end 20 to an opposite end 22. The central wire 12 extends a length along the longitudinal axis 18 from an end 24 to an opposite end 26. In the exemplary embodiment of FIGS. 1-3, the force wires 14 and the return wires 16 are wrapped in a helical configuration around a periphery of the central wire 12 along the length of the central wire 12. However, as will be described below, in alternative to the helical configuration, the force wires 14 and the return wires 16 may be wrapped around the periphery of the central wire 12 in a different configuration, such as, but not limited to, in a braided configuration, a served configuration, and/or the like. A portion of the central wire 12 is shown in phantom lines in FIG. 1 for clarity. Each force wire 14 is shaped as a coil with ends 28 and 30, and each return wire 16 is shaped as a coil with ends 32 and 34. The force and return wires 14 and 16, respectively, have winding turns 17 and 19 that are located adjacent one another in an interleaved manner. For example, in the exemplary embodiment, the winding turns 17 and 19 of the force and return wires 14 and 16, respectively, are alternatingly wrapped around the central wire 12. As described above, the winding turns 17 and 19 of the force and return wires 14 and 16, respectively, extend along helical paths around the periphery of the central wire 12.

FIG. 2 is a perspective view of a portion of the cable 10 illustrating the helical path of one of the force wires 14a. The return wires 16 and the other force wires 14b and 14c have been removed from FIG. 2 for clarity. As can be seen in FIG. 2, the force wire 14a is wrapped around the periphery of the central wire 12 such that the force wire 14a extends along a helical path between the ends 28 and 30 (FIG. 1) thereof.

Referring again to FIG. 1, each of the ends 24 and 26 of the central wire 12 may be connected to any device (not shown), such as, but not limited to, an electrical device, an optical device, a mechanical device, and/or the like. Similarly, the ends 28 and 30 of the force wires 14 and the ends 32 and 34 of the return wires 16 may be connected to any device, such as, but not limited to, an electrical device, an optical device, a mechanical device, and/or the like. Examples of electrical devices include, but are not limited to, printed circuit boards, electrical power sources, electrical connectors, and/or the like. When the cable 10 is utilized to conduct electrical power, at least one of the force wires 14 conducts power flow and one or more of the return wires 16 may provide a return path for the electrical power flow. When the cable 10 is utilized to conduct signals, at least one of the force wires 14 conduct data signals and one or more of the return wires 16 may provide a return path. In the exemplary embodiment of FIGS. 1-3, the center wire 12 is a sense line that conducts a voltage reference signal associated with the electrical power flow conducted by the force wires 14. For example, the voltage reference signal may indicate a value of the voltage that is being conducted along the force wires 14. In addition or alternative to the voltage reference signal, the center wire 12 may conduct other signals (including, but not limited to, electrical signals, optical signals, mechanical signals, and/or the like), electrical power flow, and/or may provide a return path.

The exemplary embodiment of the cable 10 includes a single central wire 12, three force wires 14, and three return wires 16. Specifically, the cable 10 includes force wires 14a, 14b, and 14c, and return wires 16a, 16b, and 16c. However, the cable 10 may include any number of the central wires 12 (having any relative arrangement) and may include any number of the force wires 14 and any number of the return wires 16. In some embodiments, the cable 10 includes two central wires 12 that are twisted around each other to define a twisted pair of wires.

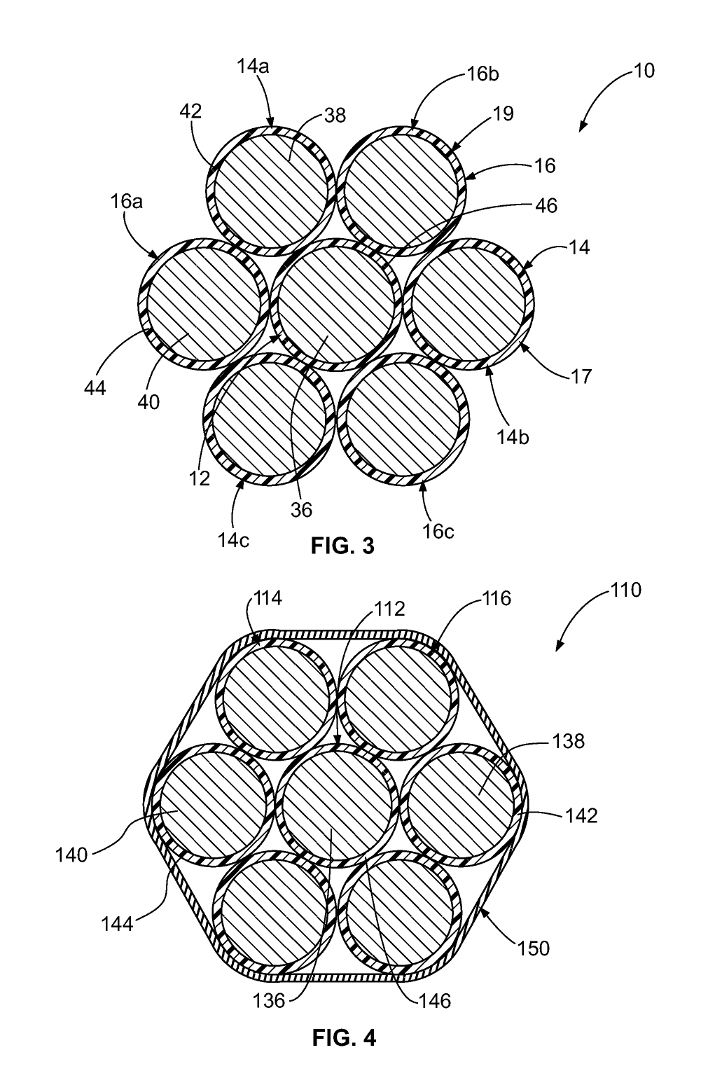

FIG. 3 is a cross sectional view of the cable 10 taken along line 3-3 of FIG. 1. In the exemplary embodiment of FIGS. 1-3, each of the force wires 14 includes an electrical conductor 38 and an electrical insulator 42 surrounding the conductor 38 along at least a portion of the length of the force wire 14. Similarly, each of the return wires 16 includes an electrical conductor 40 and an electrical insulator 44 surrounding the conductor 40 along at least a portion of the length of the return wire 16. In an alternative embodiment, one or more of the force wires 14 and/or one or more of the return wires 16 includes an optical fiber (not shown) in place of the respective conductor 38 and 40. In such an alternative embodiment, the force wire(s) 14 and/or the return wires(s) 16 that include the optical fiber(s) may not include an insulator.

In the exemplary embodiment of FIGS. 1-3, the central wire 12 includes a conductor 36, for example to enable the central wire 12 to conduct the voltage reference signal. The central wire 12 also includes an optional electrical insulator 46 that surrounds the conductor 36 along at least a portion of the length of the central wire 12. In some alternative embodiments, the central wire 12 does not include the insulator 46 and the conductor 36 thereof is electrically insulated from the conductors 38 and 40 solely by the insulators 42 and 44. Although only a single central wire 12 is shown in FIGS. 1-3, as described above the cable 10 may include any number of central wires 12. For example, the cable 10 may include two or more central wires 12 that each operates as a different sense line (such as, but not limited to, a force sense line and a return sense line, and/or the like).

Each of the conductors 36, 38, and 40 may include any number of strands. The insulator 46 may be referred to herein as a “central insulator”. The insulators 42 and 44 may be referred to herein as “force insulators” and “return insulators”, respectively. The conductor 36 may be referred to herein as a “central conductor”, while the conductors 38 and 40 may be referred to herein as “force conductors” and “return conductors”, respectively.

The force wires 14 and the return wires 16 may be held in position around the central wire 12 using any method, structure, means, and/or the like. In the exemplary embodiment of FIGS. 1-3, a stiffness of the force and return wires 14 and 16, respectively, prevents the wires 14 and 16 from unwrapping from the central wire 12. In addition or alternative, connection of the ends 28 and 30 of the force wires 14 and/or connections of the ends 32 and 34 of the return wires 16 to the devices may prevent the wires 14 and/or 16 from unwrapping from the central wire 12. Mechanical connections and/or chemical bonding between the insulators 42, 44, and/or 46 could also be used to hold the force wires 14 and/or the return wires 16 in position around the central wire 12. Examples of mechanical connections between the insulators 42, 44, and/or 46 include, but are not limited to, adhesives, mechanical fasteners (such as, but not limited to, straps and/or the like), and/or the like.

In addition or alternative to the stiffness and/or connections described above, an optional cable jacket may surround the force and return wires 14 and 16, respectively. For example, FIG. 4 is a cross-sectional view of an exemplary alternative embodiment of an electrical cable 110. The cable 110 includes a central wire 112, a plurality of force wires 114, and a plurality of return wires 116. The force and return wires 114 and 116, respectively, are wrapped in a helical manner around a periphery of the central wire 112 along the length of the central wire 112. Although not visible in FIG. 4, the force and return wires 114 and 116, respectively, have winding turns that are located adjacent one another in an interleaved manner.

The central wire 112 includes an electrical conductor 136 and an optional electrical insulator 146 that surrounds the conductor 136. The force and return wires 114 and 116, respectively, include respective electrical conductors 138 and 140 and respective electrical insulators 142 and 144 that surround the conductors 138 and 140. A cable jacket 150 surrounds the force and return wires 114 and 116, respectively, along at least a portion of the length of the wires 114 and 116. The cable jacket 150 holds the wires 114 and 116 in position around the central wire 112. The cable jacket 150 is optionally fabricated from an electrically insulating material. Alternatively, the cable jacket 150 may be fabricated from an electrically conductive material to provide shielding and/or electrical isolation. The cable jacket 150 is optionally fabricated from a material that facilitates protecting the wires 12, 14, and 16 from environmental threats such as, but not limited to, dirt, debris, heat, cold, fluids, impact damage, and/or the like.

Referring again to FIGS. 1 and 3, in the exemplary embodiment, the winding turns 17 and 19 of the force and return wires 14 and 16, respectively, are alternatingly wrapped around the central wire 12. The winding turns 19 of the return wires 16 are interleaved between the winding turns 17 of adjacent force wires 14 along the helical paths such that the adjacent force wires 14 are separated by return wires 16. As can be seen in both FIGS. 1 and 3, the force wires 14a and 14c are separated by the return wire 16a, the force wires 14a and 14b are separated by the return wire 16b, and the force wires 14b and 14c are separated by the return wire 16c.

The exemplary pattern of the force and return wires 14 and 16, respectively, of the cable 10 may facilitate reducing an inductance of the cable 10 and/or may facilitate increasing a capacitance of the cable 10. For example, the exemplary pattern of the force wires 14 and the return wires 16 may facilitate reducing an inductance, and/or increasing a capacitance, between the force wires 14 and the return wires 16. A thickness of the insulators 42, 44, and/or 46 may be selected to provide a predetermined inductance and/or a predetermined capacitance between the wires 12, 14, and/or 16. In addition or alternatively, a material of the insulators 42, 44, and/or 46 may be selected to provide the predetermined capacitance between the wires 12, 14, and/or 16. Each insulator 42, 44, and 46 may have any thickness that enables the insulator 42, 44, and 46 to provide the predetermined inductance and/or predetermined capacitance. Examples of insulator thicknesses include, but are not limited to, a thickness of between approximately 0.001 inch (0.0254 millimeter) and approximately 0.01 inch (0.254 millimeter), a thickness of between approximately 0.0001 inch (0.00254 millimeter) and approximately 0.001 inch (0.0254 millimeter), a thickness of between approximately 0.0002 inch (0.00508 millimeter) and approximately 0.0008 inch (0.02032 millimeter), and/or the like. Any other thicknesses for the insulators 42, 44, and/or 46 may be used, which may depend on a size of the conductors 36, 38, and/or 40, a number of the wires 12, 14, and/or 16, a length of the cable 10, the operational environment and/or intended use of the cable 10, other factors, and/or the like.

Although each of the adjacent force wires 14 is separated by a return wire 16 in the exemplary embodiment of FIGS. 1-3, only some adjacent force wires 14 may be separated by a return wire 16. Any number of adjacent force wires 14 may be separated by a return wire 16. Moreover, in some alternative embodiments, some or all adjacent force wires 14 are separated by more than one return wire 16.

As described above, in alternative to the helical configuration, the winding turns 17 and 19 of the force wires 14 and the return wires 16, respectively, may be wrapped around the periphery of the central wire 12 in a different winding configuration, such as, but not limited to, in a braided configuration, a served configuration, and/or the like. For example, the winding turns 17 and 19 of the force and return wires 14 and 16, respectively, may extend along braided or served paths around the periphery of the central wire 12. In some alternative embodiments, the cable 10 includes more than one layer of wires wrapped around the periphery of the central wire 12. Each layer may include only force wires 14, only return wires 16, or both force wires 14 and return wires 16. Different layers may have different winding directions and/or different winding configurations from other layers. For example, in some alternative embodiments the cable 10 includes a layer of force wires 14 wrapped around the central wire 12 in a first direction, and a layer of return wires 16 wrapped around the central wire 12 in a second direction that is opposite the first direction. Another example of an alternative embodiment of the cable 10 includes a layer of force wires 14 and return wires 16 wrapped around the central wire 12 in a helical configuration, and a layer of force wires 14 and return wires 16 wrapped around the central wire 12 in a braided configuration.

In the exemplary embodiment of FIGS. 1-3, the central wire 12 includes the conductor 36 and the insulator 46. But, the central wire 12 may include other structures in addition or alternative to the conductor 36 and/or the insulator 46. For example, the central wire 12 may include a coaxial cable, a twinaxial cable, a fiber optic cable, a conduit (such as, but not limited to, a fluid conduit), and/or the like. One example of an embodiment wherein the central wire 12 includes a fiber optic cable is a cable (not shown) wherein the conductor 36 of the central wire 12 is replaced with an optical fiber (not shown). Another example includes providing the central wire 12 with a fiber optic cable (not shown) in addition to the conductor 36.

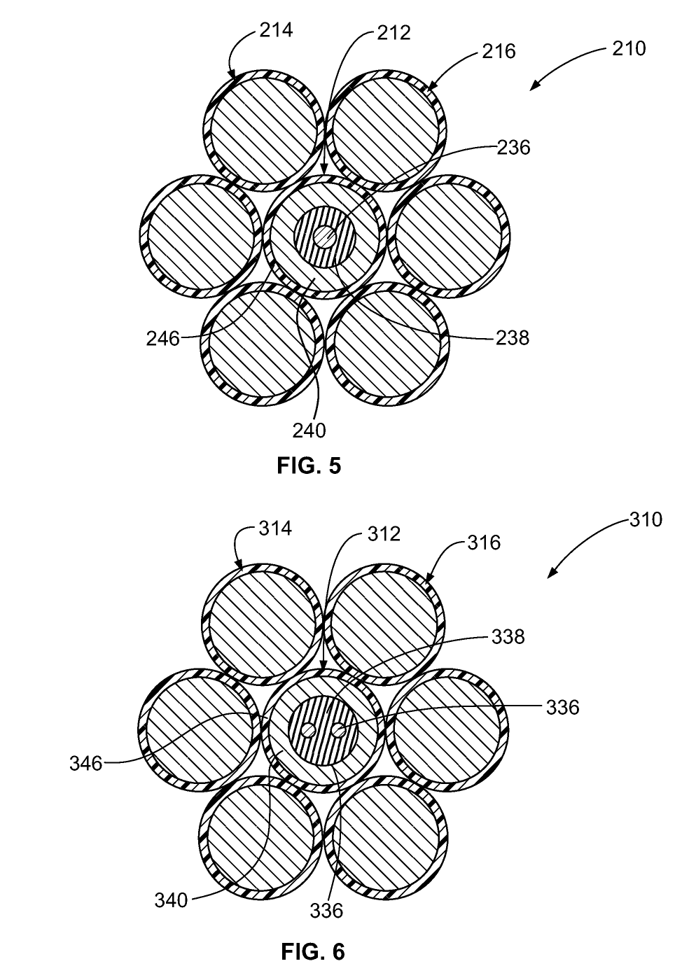

FIG. 5 is a cross-sectional view of an exemplary alternative embodiment of an electrical cable 210. The electrical cable 210 includes a central wire 212, a plurality of force wires 214, and a plurality of return wires 216. The force and return wires 214 and 216, respectively, are wrapped in a helical manner around a periphery of the central wire 212 along the length of the central wire 212. The force and return wires 214 and 216, respectively, have winding turns that are located adjacent one another in an interleaved manner. The central wire 212 is a coaxial cable. Specifically, the central wire 212 includes an inner electrical conductor 236, an electrical insulator 238 surrounding the inner conductor 236, an outer electrical conductor 240 surrounding the insulator 238, and an electrical insulator 246 surrounding the outer conductor 240. The central wire 212 may conduct data signals, return paths, and/or electrical power. For example, the inner conductor 236 may conduct electrical power flow and the outer conductor 240 may provide a return path, or vice versa. Moreover, and for example, the inner conductor 236 may conduct data signals and the outer conductor 240 may provide a return path, or vice versa. In some embodiments, the inner conductor 236 is a force sense line and the outer conductor 240 is a return sense line, or vice versa.

FIG. 6 is a cross-sectional view of another exemplary alternative embodiment of an electrical cable 310. The electrical cable 310 includes a central wire 312, a plurality of force wires 314, and a plurality of return wires 316. The force and return wires 314 and 316, respectively, are wrapped in a helical manner around a periphery of the central wire 312 along the length of the central wire 312. The force and return wires 314 and 316, respectively, have winding turns that are located adjacent one another in an interleaved manner. The central wire 312 is a twinaxial cable. Specifically, the central wire 312 includes a pair of inner electrical conductors 336, an electrical insulator 338 surrounding the inner conductors 336, an outer electrical conductor 340 surrounding the insulator 338, and an electrical insulator 346 surrounding the outer conductor 340. The central wire 312 may conduct data signals, return paths, and/or electrical power. For example, the inner conductors 336 may conduct electrical power flow and the outer conductor 340 may provide a return path, or vice versa. Moreover, and for example, the inner conductors 336 may conduct data signals and the outer conductor 340 may provide a return path, or vice versa. One of the inner conductors 336 could conduct electrical power flow while the other inner conductor 336 provides a return path. Similarly, one of the inner conductors 336 could conduct data signals while the other inner electrical conductor provides a return path. In some embodiments, one of the inner conductors 336 is a force sense line and the outer inner conductor 336 is a return sense line.

FIG. 10 is a cross-sectional view of another exemplary alternative embodiment of an electrical cable 610. The electrical cable 610 includes a pair of central conduits 612, a plurality of force wires 614, and a plurality of return wires 616. The force and return wires 614 and 616, respectively, are wrapped in a helical manner around a periphery of the central conduits 612 along the length of the central conduits 612. The force and return wires 614 and 616, respectively, have winding turns that are located adjacent one another in an interleaved manner. The central conduits 612 are each configured to carry fluid. Specifically, the central conduit 612a delivers fluid to a device connected to the cable 610 for cooling the device, while the central conduit 612b carries the fluid after the fluid has absorbed heat from the device. In other words, the central conduit 612a provides a delivery path of cooling fluid to the device and the central conduit 612b provides a return path of the fluid back the source thereof. Although shown as having an oval cross-sectional shape, each of the central conduits 612 may additionally or alternatively include any other shape.

Referring again to FIG. 1, in the exemplary embodiment, the electrical conductor 36 of the central wire 12 is shown as exposed at the ends 24 and 26 for connection to the corresponding devices. Similarly, the electrical conductors 38 and 40 of the force and return wires 14 and 16, respectively, are shown as exposed for connection to the corresponding devices. In some alternative embodiments, one or more of the conductors 36, 38, and 40 may not be exposed for connection to the corresponding devices. Rather, connection between the conductors 36, 38, and 40 and the devices may be made through the respective insulator 42, 44, and 46.

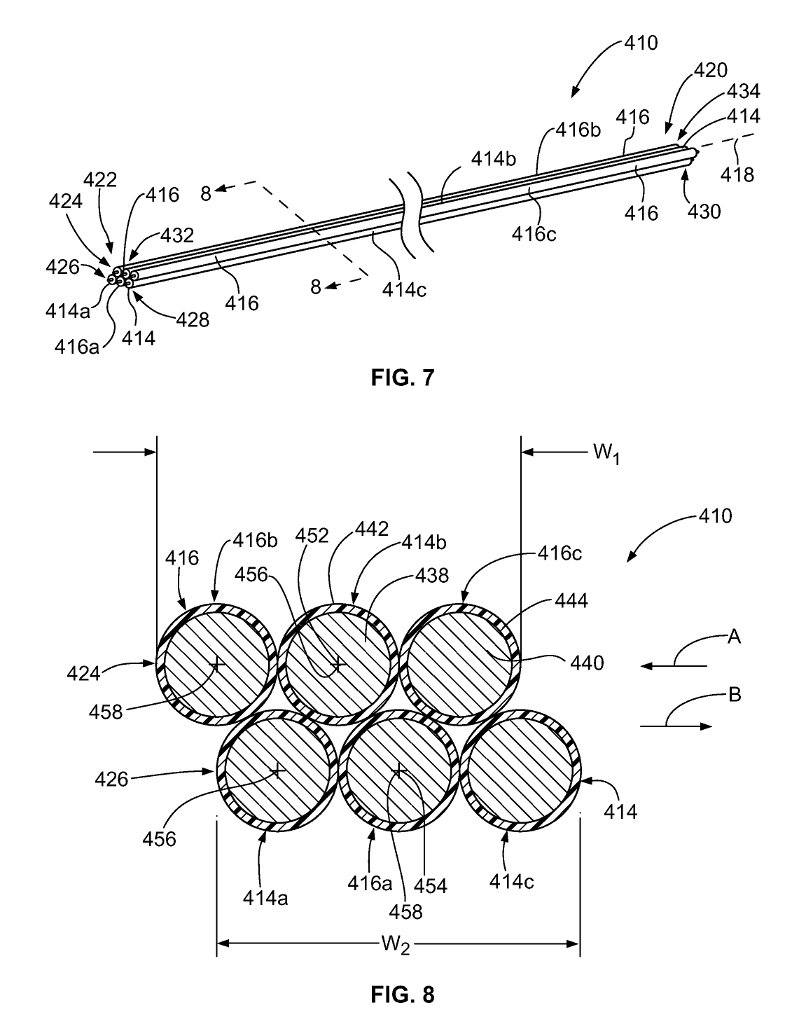

FIG. 7 is a perspective view of another exemplary embodiment of an electrical cable 410. The electrical cable 410 includes a plurality of force wires 414 and a plurality of return wires 416. The cable 410 extends a length along a central longitudinal axis 418 from an end 420 to an opposite end 422. In the exemplary embodiment, the force wires 414 and the return wires 416 are arranged side by side in a pair of rows 424 and 426, which are stacked. Each force wire 414 extends from an end 428 to an opposite end 430, and each return wire 416 extends from an end 432 to an opposite end 434. The ends 428 and 430 of the force wires 414 and the ends 432 and 434 of the return wires 416 may be electrically connected to any device (not shown), such as, but not limited to, an electrical device, an optical device, a mechanical device, and/or the like. Examples of electrical devices include, but are not limited to, printed circuit boards, electrical power sources, electrical connectors, and/or the like. When the cable 410 is utilized to conduct electrical power, at least one of the force wires 414 conduct power flow and the one or more of the return wires 416 may provide a return path for the electrical power flow. When the cable 410 is utilized to conduct signals, at least one of the force wires 414 conduct data signals and one or more of the return wires 416 provide a return path. In some alternative embodiments, one or more of the force wires 414 and/or one or more of the return wires 416 is a sense line that, for example, conducts a voltage reference signal. Each of the rows 424 and 426 may be referred to herein as a “first row” and/or a “second row”.

The exemplary embodiment of the cable 410 includes three force wires 414 and three return wires 416. Specifically, the cable 410 includes force wire 414a, 414b, and 414c, and return wires 416a, 416b, and 416c. However, the cable 410 may include any number of the force wires 414 and any number of the return wires 416. Moreover, the cable 410 may include any number of rows of the wires 414 and 416. Each row may include any number of wires 414 and 416 overall, and each row may include any number of the force wires 414 and any number of the return wires 416. Although two rows 424 and 426 are shown, the cable 410 may include any number of rows.

FIG. 8 is a cross sectional view of the cable 410 taken along line 8-8 of FIG. 7. Each of the force wires 414 includes an electrical conductor 438 and an electrical insulator 442 surrounding the conductor 438 along at least a portion of the length of the force wire 414. Each of the return wires 416 includes an electrical conductor 440 and an electrical insulator 444 surrounding the conductor 440 along at least a portion of the length of the return wire 416. In an alternative embodiment, one or more of the force wires 414 and/or one or more of the return wires 416 includes an optical fiber (not shown) in place of the respective conductor 438 and 440. In such an alternative embodiment, the force wire(s) 414 and/or the return wires(s) 416 that include the optical fiber(s) may not include an insulator.

Each of the rows 424 and 426 extends a length along a respective central longitudinal axis 452 and 454. Respective row widths W₁ and W₂ are defined by the side by side arrangement of the wires 414 and 416 within the rows 424 and 426. The force wires 414 extend lengths along corresponding central longitudinal axes 456 and the return wires 416 extend lengths along corresponding central longitudinal axes 458. The insulators 442 and 444 may be referred to herein as “force insulators” and “return insulators”, respectively. The conductors 438 and 440 may be referred to herein as “force conductors” and “return conductors”, respectively. The central longitudinal axes 452 and 454 may each be referred to herein as a “first central longitudinal axis” and/or a “second central longitudinal axis”. The widths W₁ and W₂ may each be referred to herein as a “first row width” and/or a “second row width”. The central longitudinal axes 456 and 458 may be referred to herein as a “force axis” and a “return axis”, respectively.

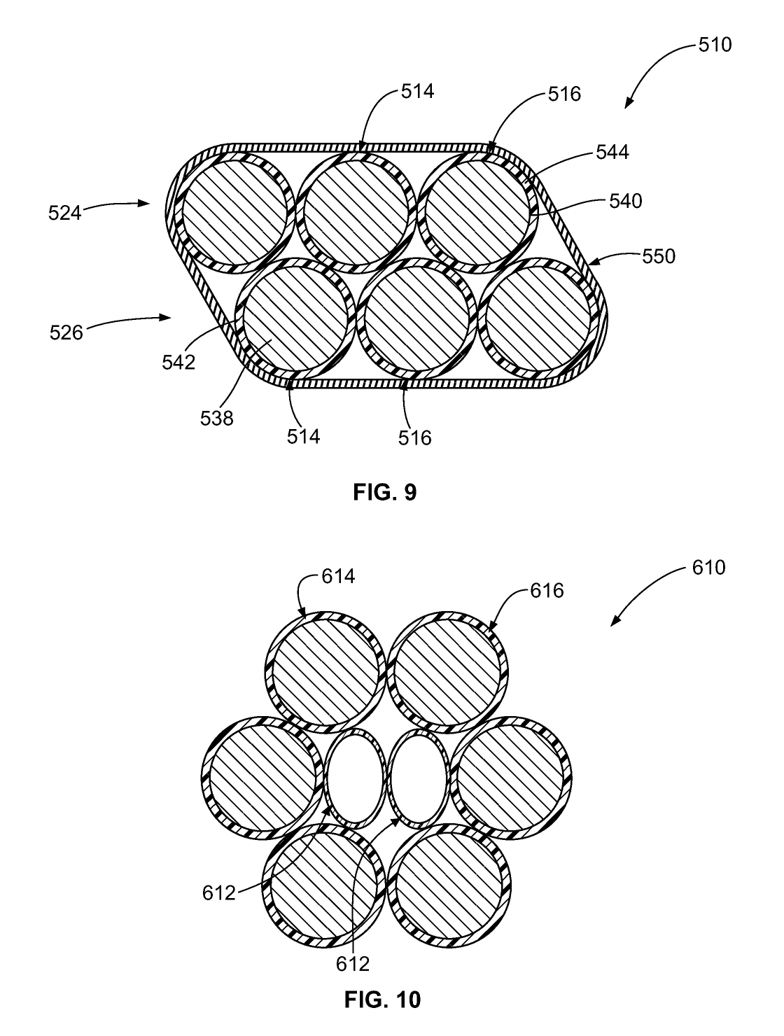

The force wires 414 and the return wires 416 may be held within the rows 424 and 426, and the rows 424 and 426 may be held together, using any method, structure, means, and/or the like. In the exemplary embodiment, mechanical connections and/or chemical bonding between the insulators 444 and/or 446 could also be used to hold the force wires 414 and/or the return wires 416 together. Examples of mechanical connections between the insulators 444 and/or 446 include, but are not limited to, adhesives, mechanical fasteners (such as, but not limited to, straps and/or the like), and/or the like. An optional cable jacket may surround the force and return wires 414 and 416, respectively, to hold the wires 414 and 416 together. For example, FIG. 9 is a cross-sectional view of an exemplary alternative embodiment of an electrical cable 510. The cable 510 includes a plurality of force wires 514 and a plurality of return wires 516. The force wires 514 and the return wires 516 are arranged side by side in a pair of rows 524 and 526, which are stacked. The force and return wires 514 and 516, respectively, include respective electrical conductors 538 and 540 and respective electrical insulators 542 and 544 that surround the conductors 538 and 540. A cable jacket 550 surrounds the rows 524 and 526 of the force and return wires 514 and 516, respectively, along at least a portion of the length of the wires 514 and 516. The cable jacket 550 holds the wires 514 and 516, and the rows 524 and 526, together. The cable jacket 550 is optionally fabricated from an electrically insulating material. Alternatively, the cable jacket 550 may be fabricated from an electrically conductive material to provide shielding and/or electrical isolation. The cable jacket 550 is optionally fabricated from a material that facilitates protecting the wires 514 and 516 from environmental threats such as, but not limited to, dirt, debris, heat, cold, fluids, impact damage, and/or the like.

Referring again to FIG. 8, in the exemplary embodiment of FIGS. 7 and 8, the force wires 414 and the return wires 16 are arranged alternatingly side by side within each of the rows 424 and 426. The return wires 416 are thereby positioned between adjacent force wires 414, and the force wires 414 are positioned between adjacent return wires 416. In other words, adjacent force wires 414 within the row 426 are separated by a return wire 416, and adjacent return wires 416 within the row 424 are separated by a force wire 414. Specifically, within the row 426, the force wires 414a and 414c are separated by the return wire 416a. Within the row 424, the return wires 416b and 416c are separated by the force wire 414b. Optionally, the central longitudinal axis 452 of the row 424 is offset from the central longitudinal axis 454 of the row 426 in the direction of the arrow A, which extends parallel to the row widths W₁ and W₂. Accordingly, the central longitudinal axes 456 of the force wires 414 within the row 426 are offset from the central longitudinal axis 456 of the force wires 414 within the row 424 in the direction of the arrow B, which extends parallel to the row widths W₁ and W₂. As can be seen in FIG. 8, the force wire 414b within the row 424 is optionally nested partially between the adjacent return wires 416b and 416c. Similarly, the return wire 416a within the row 426 is optionally nested partially between the adjacent force wires 414a and 414c.

The exemplary pattern of the force and return wires 414 and 416, respectively, may facilitate reducing an inductance of the cable 410 and/or may facilitate increasing a capacitance of the cable 410. For example, the exemplary pattern of the force wires 414 and the return wires 416 may facilitate reducing an inductance, and/or increasing a capacitance, between the force wires 414 and the return wires 416. A thickness of the insulators 442 and/or 444 may be selected to provide a predetermined inductance and/or a predetermined capacitance between the wires 414 and/or 416. In addition or alternatively, a material of the insulators 442 and/or 444 may be selected to provide the predetermined capacitance between the wires 414 and/or 416. Each insulator 442 and 444 may have any thickness that enables the insulator 442 and 444 to provide the predetermined inductance. Examples of insulator thicknesses include, but are not limited to, a thickness of between approximately 0.001 inch (0.0254 millimeter) and approximately 0.01 inch (0.254 millimeter), a thickness of between approximately 0.0001 inch (0.00254 millimeter) and approximately 0.001 inch (0.0254 millimeter), a thickness of between approximately 0.0002 inch (0.00508 millimeter) and approximately 0.0008 inch (0.02032 millimeter), and/or the like. Any other thicknesses for the insulators 442 and/or 444 may be used, which may depend on a size of the conductors 438 and/or 440, a number of the wires 414 and/or 416, a length of the cable 410, the operational environment and/or intended use of the cable 410, other factors, and/or the like.

Although adjacent force wires 414 within a row are separated by a return wire 416, only some adjacent force wires 414 within a row could be separated by a return wire 416. Similarly, only some adjacent return wires 416 within a row could be separated by a force wire 414. Any number of adjacent force wires 414 within a row may be separated by a return wire 416, and any number of adjacent return wires 416 within a row may be separated by a force wire 414. Moreover, in some alternative embodiments, some or all adjacent force wires 414 within a row are separated by more than one return wire 416. In other words, two adjacent force wires 414 may be separated by more than one return wire 416.

In addition to the force wires 414 and the return wires 416, each row 424 and 426 may include other structures. For example, the rows 424 and 426 may each include a coaxial cable, a twinaxial cable, a fiber optic cable, a conduit (such as, but not limited to, a fluid conduit), and/or the like. Moreover, in addition to the rows 424 and 426, the cable 410 may include a row (not shown) that includes force wires 414 but does not include any return wires 416, and/or vice versa. In some alternative embodiments, the row 424 includes force wires 414 but does not include any return wires 416, and the row 426 includes return wires 416 but does not include any force wires 414.

Referring again to FIG. 7, in the exemplary embodiment, the electrical conductors 438 and 440 of the force and return wires 414 and 416, respectively, are shown as exposed for connection to the corresponding electrical devices. In some alternative embodiments, one or more of the conductors 438 and 440 may not be exposed for connection to the corresponding electrical devices. Rather, connection between the conductors 438 and 440 and the electrical devices may be made through the respective insulator 442 and 444.

The embodiments described and/or illustrated herein may provide an electrical cable having a reduced inductance and/or an increased capacitance as compared with some known electrical cables. For example, the embodiments described and/or illustrated herein may provide an electrical cable having a reduced inductance, and/or an increased capacitance, between force wires and return wires of the cable than at least some known electrical cables. The embodiments described and/or illustrated herein may provide an electrical cable that is less expensive and/or easier to manufacture as compared to at least some known electrical cables having a similar inductance and/or capacitance. The embodiments described and/or illustrated herein may provide an electrical cable that is less expensive and/or easier to terminate than at least some known electrical cables.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter described and/or illustrated herein without departing from its scope. Dimensions, types of materials, orientations of the various components, and the number and positions of the various components described and/or illustrated herein are intended to define parameters of certain embodiments, and are by no means limiting and are merely exemplary embodiments. Many other embodiments and modifications within the spirit and scope of the claims will be apparent to those of skill in the art upon reviewing the above description and the drawings. The scope of the subject matter described and/or illustrated herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. An electrical cable comprising:
a central wire extending a length between opposite ends, the central wire having a periphery;
force wires having winding turns wrapped around the periphery of the central wire along the length of the central wire, the force wires comprising force conductors surrounded by force insulators; and
return wires having winding turns wrapped around the periphery of the central wire along the length of the central wire, the return wires comprising return conductors surrounded by return insulators, wherein the winding turns of the return wires are interleaved between the winding turns of adjacent force wires such that the adjacent force wires are separated by at least one return wire.

2. The electrical cable according to claim 1, wherein the winding turns of the force wires are wrapped around the periphery of the central wire along helical paths, the winding turns of the return wires being wrapped around the periphery of the central wire along helical paths.

3. The electrical cable according to claim 1, wherein the central wire comprises a central conductor and a central insulator surrounding the central conductor, the winding turns of the force and return wires being wrapped around the central insulator.

4. The electrical cable according to claim 1, wherein the winding turns of the force and return wires are wrapped alternatingly around the central wire such that adjacent force wires are separated by one of the return wires.

5. The electrical cable according to claim 1, wherein the force wires are configured to carry at least one of electrical power flow and data signals, the return wires providing a return path.

6. The electrical cable according to claim 1, wherein the center wire comprises a plurality of wires.

7. The electrical cable according to claim 1, wherein the central wire comprises at least one of a coaxial cable, a twinaxial cable, a fiber optic cable, a fluid conduit, and a sense line.

8. The electrical cable according to claim 1, wherein at least one of a thickness of at least one of the force insulators and a thickness of at least one of the return insulators is at least one of:
between approximately 0.0001 inch (0.00254 millimeter) and approximately 0.001 inch (0.0254 millimeter);
between approximately 0.0002 inch (0.00508 millimeter) and approximately 0.0008 inch (0.02032 millimeter); and
between approximately 0.001 inch (0.0254 millimeter) and approximately 0.01 inch (0.254 millimeter).

9. The electrical cable according to claim 1, further comprising a jacket surrounding the force and return wires.

10. The electrical cable according to claim 1, wherein at least one of the force wires and the return wires comprises a fiber optic cable.

11. An electrical cable comprising:
force wires comprising force conductors surrounded by force insulators; and
return wires comprising return conductors surrounded by return insulators, the force and return wires being arranged side by side in a first row and side by side in a second row that is stacked on the first row, wherein a return wire within the first row is positioned between adjacent force wires within the first row such that the adjacent force wires are separated by at least one return wire, and wherein a force wire within the second row is positioned between adjacent return wires within the second row such that the adjacent return wires are separated by at least one force wire.

12. The electrical cable according to claim 11, wherein the force and return wires are arranged alternatingly side by side within the first and second rows.

13. The electrical cable according to claim 11, further comprising a third row of force wires and a fourth row of return wires, wherein the third row does not include any return wires and the fourth row does not include any force wires.

14. The electrical cable according to claim 11, wherein the first row and the second row extend lengths along respective first and second central longitudinal axes, the first and second rows having respective first and second row widths defined by the side by side arrangement of the force and return wires, the second central longitudinal axis being offset from the first central longitudinal axis in a direction parallel to the first and second row widths.

15. The electrical cable according to claim 11, wherein a force wire within the second row is nested partially between adjacent force and return wires within the first row.

16. The electrical cable according to claim 11, wherein the force and return wires extend lengths along respective force and return axes, the first and second rows having respective first and second row widths defined by the side by side arrangement of the force and return wires, wherein the force axes of the force return wires within the second row are offset from the force axes of the force wires within the first row in a direction that is parallel to the first and second row widths.

17. The electrical cable according to claim 11, wherein the force wires are configured to carry at least one of electrical power flow and data signals, the return wires providing a return path.

18. The electrical cable according to claim 11, wherein at least one of a thickness of at least one of the force insulators and a thickness of at least one of the return insulators is at least one of:
between approximately 0.0001 inch (0.00254 millimeter) and approximately 0.001 inch (0.0254 millimeter);
between approximately 0.0002 inch (0.00508 millimeter) and approximately 0.0008 inch 0.02032 millimeter); and
between approximately 0.001 inch (0.0254 millimeter) and approximately 0.01 inch (0.254 millimeter).

19. The electrical cable according to claim 11, further comprising a jacket surrounding the first and second rows.

20. The electrical cable according to claim 11, wherein at least one of the force wires and the return wires comprises a fiber optic cable.

21. The electrical cable according to claim 11, wherein at least one of the first row and the second row comprises at least one of a coaxial cable, a twinaxial cable, a fiber optic cable, a fluid conduit, and a sense line.
